(19) United States
(12) Patent Application Publication
(10) Pub. No.: US 2014/0279333 A1
(43) Pub. Date: Sep. 18, 2014

(54) CONTRACT AUTOMATION APPARATUS, METHOD, AND COMPUTER PROGRAM PRODUCT

(71) Applicant: Time Warner Cable Enterprises LLC, New York, NY (US)

(72) Inventors: Sean M. Galvin, Epping, NH (US); Amyn Kassim-Lakha, Cambridge, MA (US); Amit Bhandari, Westborough, MA (US); David Grimes, Cazenovia, NY (US); George Kusner, Clay, NY (US)

(21) Appl. No.: 14/208,199

(22) Filed: Mar. 13, 2014

Related U.S. Application Data
(60) Provisional application No. 61/786,386, filed on Mar. 15, 2013.

(51) Int. Cl. G06Q 10/06; G06Q 40/00

(52) U.S. Cl. CPC G06Q 10/06; G06Q 40/00
USPC 705/35; 705/342

(57) ABSTRACT

On a persistent storage device, a database of contracts is maintained. The database has at least one record for each of the contracts. The at least one record for each of the contracts includes at least one field comprising a corresponding contract end date. At a computer processor in communication with the persistent storage device, at least one user query is obtained. Responsive to the at least one user query, a signal is generated with the computer processor to cause a display device to display a histogram of the corresponding contract end date for at least one of the contracts.

### CROSS-REFERENCE TO RELATED APPLICATION(S)

This application claims the benefit of U.S. Provisional Application Ser. No. 61/786,386, filed on Mar. 15, 2013, the complete disclosure of which is expressly incorporated herein by reference in its entirety for all purposes.

### FIELD OF THE INVENTION

The present invention relates generally to the computer and electronic arts, and, more particularly, to software and system components for contract administration, and the like.

### BACKGROUND OF THE INVENTION

Currently, contracts are reviewed manually. Some contracts are dynamic and extensible. Manual review of such contracts results in inefficient repetition when minor changes are made, as well as the inability to track projected obligations and/or revenues, for long-term forecasting or in case of mergers and acquisitions.

### SUMMARY OF THE INVENTION

Principles of the present invention provide techniques for contract automation. In one aspect, an exemplary method includes the step of maintaining, on a persistent storage device, a database of contracts. The database has at least one record for each of the contracts. The at least one record for each of the contracts includes at least one field comprising a corresponding contract end date. Further steps include obtaining, at a computer processor in communication with the persistent storage device, at least one user query; and, responsive to the at least one user query, generating, with the computer processor, a signal to cause a display device to display a histogram of the corresponding contract end date for at least one of the contracts.

In another aspect, another exemplary method includes maintaining, on a persistent storage device, a database of contracts. The database has at least one record for each of the contracts. The at least one record for each of the contracts includes at least one field comprising a review-based reliability status. Additional steps include obtaining, from an external application, at at least one computer processor in communication with the persistent storage device, updated data comprising at least one of a new contract and an exchange to an existing one of the contracts; updating, in the database on the persistent storage device, the at least one field comprising the review-based reliability status for at least one of: at least one of the contracts and the new contract, based on the updated data; and, responsive to at least one user query, generating, with the computer processor, a signal to cause a display device to display the updated field comprising the review-based reliability status for the at least one of: the at least one of the contracts and the new contract.

In a further aspect, still another exemplary method includes maintaining, on a persistent storage device, a database of contracts. The database has at least one record for each of the contracts. The at least one record for each of the contracts includes at least one field comprising implementation date. Further steps include obtaining, at a computer processor in communication with the persistent storage device, at least one user query; and, responsive to the at least one user query, generating, with the computer processor, a signal to cause a display device to display a list comprising at least a portion of the contracts for which the implementation date field is blank.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a machine readable medium that contains one or more programs which when executed implement such step(s); that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein. The means do not include a transmission medium per se or a disembodied signal per se.

Techniques of the present invention can provide substantial beneficial technical effects, as will be appreciated by the skilled artisan from the present specification. For example, one or more embodiments provide a technique to more quickly and accurately visualize which contracts in a database of contracts will soon expire; which contracts in a database of contracts have data that can be considered as reliable; and/or which contracts in a database of contracts have one or more orders not yet implemented and/or pending legal review.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a main screen of a contract automation tool, in accordance with an aspect of the invention;

FIG. 2 depicts a customer listing screen of the contract automation tool of FIG. 1, showing customers having monthly recurring revenue (MRR), in accordance with an aspect of the invention;

FIG. 3 depicts the screen of FIG. 2, with an expiration date pop-up, in accordance with an aspect of the invention;

FIG. 4 depicts the screen of FIG. 2, with a note pop-up, in accordance with an aspect of the invention;

FIG. 5 depicts a sales order status screen for one of the customers of FIG. 2, in accordance with an aspect of the invention;

FIG. 6 depicts a sales order detail screen for one of the sales orders of FIG. 5, in accordance with an aspect of the invention;

FIG. 7 depicts a sales order detail screen for one of the sales orders of FIG. 5, in accordance with an aspect of the invention;

FIG. 8 depicts a sales order histogram screen for several of the sales orders of FIG. 5, in accordance with an aspect of the invention;

FIG. 9 depicts a customer listing screen of the contract automation tool of FIG. 1, showing customers having not-implemented orders, in accordance with an aspect of the invention;

FIG. 10 depicts a customer listing screen of the contract automation tool of FIG. 1, showing customers having orders pending legal review, in accordance with an aspect of the invention;

FIG. 11 depicts a screen with the results of a search using the contract automation tool of FIG. 1, in accordance with an aspect of the invention;

FIG. 12 depicts a sales order reset screen reached by selecting the “Recalculate Customer Orders” link of FIG. 5, in accordance with an aspect of the invention;

FIG. 13 is a system block diagram of a contract automation apparatus, in accordance with an aspect of the invention;

FIG. 14 is a block diagram of a computer system useful in connection with one or more aspects of the invention;

FIG. 15 shows results of a search yielding an alphabetical listing, in accordance with an aspect of the invention;

FIG. 16 shows a note entry screen, in accordance with an aspect of the invention;

FIG. 17 shows the effect of exemplary sales order terms, in accordance with an aspect of the invention; and

FIG. 18 is a view similar to FIG. 1, showing alternative status indicators, in accordance with an aspect of the invention.

### DETAILED DESCRIPTION OF PREFERRED EMBODIMENTS

One or more embodiments provide a contract management tool which assists internal departments of an organization for better all-around account management, sales operations, finance operations, legal operations, and/or customer service. One or more embodiments significantly increase an employee's readily available knowledge base regarding the contractual obligations of one or more customers (and obligations of the employee's employer to those customers), and/or significantly reduce contract administration and review time. In at least some cases, access to the tool's data can be based on permissions that can limit or expand access based on need or authority.

In at least some cases, the tool allows readily ascertaining contract end dates, tracking contracts, and/or managing software.

Reference should now be had to FIG. 1, which shows a home page of a contract administration tool, in accordance with an aspect of the invention. The username is displayed at 101 and a logout option is provided at 103, in a conventional manner. The user may select “contract” tab 105 to access the depicted customer search page, or, in some instances, may access another tab such as “compliance” tab 107 to access compliance or other functionality. Furthermore in this regard, in one or more embodiments the Contract Automation tool accessed by tab 105 can be a functional module presented through a larger internal portal, which also includes other functionality such as represented by tab 107. One or more embodiments provide the ability to see all current active customers and to synchronize with other systems in the organization (this aspect is discussed further with respect to FIG. 13 below) so that, as new customers are added, the system is updated with their details, e.g., current revenue, customer name, customer sales order details, and so on.

A customer name or portion thereof can be entered in search box 123; “return” can be hit or “find” button 125 clicked to initiate the search. In another aspect, the user may click on “MRR List” link 127; “Not-Implemented Orders List” link 129; or “Orders Pending Legal Review” link 131. Clicking link 127 takes the user to a listing of customers by monthly recurring revenue (MRR), as discussed, for example, with respect to FIGS. 2-4. Clicking link 129 takes the user to a listing of customers having orders that have not yet been implemented, as discussed, for example, with respect to FIG. 9. Clicking link 131 takes the user to a listing of customers having orders that have not yet been reviewed by the legal department, as discussed, for example, with respect to FIG. 10.

In some instances, the tool is provided with a visual indicator of the status of the entry for a given contract; for example, a legend such as shown at 109, 111, 113. In some instances, the legend includes a red, green, and yellow button feature that indicates the current status of the contract and records review and whether same should currently be relied upon, based on the color scheme (e.g., green 109 is reliable; yellow 111 has had a new order loaded since the last legal audit and should not be relied upon; red 113 has not been reviewed by legal and should not be relied upon).

In some cases, manual review is used to change the red, green, or yellow buttons 109, 111, 113. However, in at least some cases, some or all of the process can be automated. For example, status may be changed from green to yellow in an automated fashion, as new orders come in, thus flagging the entries so that the legal team can have a chance to review. See discussion of interface with other systems in connection with FIG. 13 below.

Color-coding or some other type of indication can also be used in connection with status filtering, as seen at 115, 117, 119, 121. The filters 115, 117, 119, 121 are applied to the search process initiated by entering a term in search box 123 as discussed above. Each option may be provided with a box that can be checked; for example, to its left. If “None” is checked at 115, no filtering is applied. If a first category 117 is checked, the search process is filtered accordingly. For example, the first category 117 could be for contracts that have an end date well out in time; say more than two years in the future. This category could be green in some cases, or could be a different color such as brown to avoid confusion with green indicator 109. If first category 117 is checked, the search process returns only contracts matching the entered search term AND having an end date more than two years in the future.

If a second category 119 is checked, the search process is again filtered accordingly. For example, the second category 119 could be for contracts that have an intermediate end date; say more than one year but less than or equal to two years in the future. This category could be yellow in some cases, or could be a different color such as blue to avoid confusion with yellow indicator 111. If second category 119 is checked, the search process returns only contracts matching the entered search term AND having an end date more than one year but less than or equal to two years in the future.

If a third category 121 is checked, the search process is once again filtered accordingly. For example, the third category 121 could be for contracts that have an imminent end date; say less than or equal to one year in the future. This category could be red in some cases, or could be a different color such as orange to avoid confusion with red indicator 113. If third category 121 is checked, the search process returns only contracts matching the entered search term AND having an end date less than or equal to one year in the future.

Of course, the colors and time periods are exemplary, and other values can be used in other embodiments.

In one or more embodiments, as seen in FIG. 15, clicking on “find” button 125 with nothing in search box 123 yields an alphabetical list of customers 349; if any of the filters 117-121 are applied, the list is filtered to include only customers in the corresponding category. Filter 117 is useful to access reliable data; filters 119 and/or 121 may be useful to access records that require audit of updates or initial review. Each hit in customer list 349 can be displayed with a corresponding status indicator 109, 111, 113 to its left.

FIG. 2 shows the result of clicking on the link 127 for “MRR List” in FIG. 1. Elements in the figures having the same reference character are similar and are not necessarily explained again with respect to each view. In the screen of FIG. 2, the user can return to the screen of FIG. 1 by clicking the “Customer Search” link 133. A first column shows a status indicator corresponding to status 109, 111, or 113 as the case may be. A second column 135 lists customers by name as it appears on their Master Services Agreement(s) (MSA(s)). A third column 139 displays the monthly recurring revenue (MRR) that is, the originally contemplated MRR at the time the order was placed. A fourth column 143 displays the active monthly recurring revenue (MRR) that is, the MRR at the current time (which may have changed from the time that the order was placed; for example, due to de-installations and/or returns of products and or services, e.g.). A fifth column 147 lists the end date. A sixth column 151 includes a flag such as “Y” if there are any notes and is discussed further below. A seventh column 153 indicates whether the contract is the result of an acquisition from another organization or the like. Hovering on the entry (here “TAU” 157) in some instances open a window with details about the “TAU” organization; e.g., TAU Medical Devices Corporation, 123 Main Street, Any Town, Kans. 12345.

Any one, some or all of the first column and columns 135, 139, 143, 147, 153 can include up-down sort arrows 165, 137, 141, 145, 149, 155 which allow the corresponding column to be sorted in increasing or decreasing order alphabetically, numerically, or otherwise, as the case may be.

The last column includes histograms in the form of color-coded bars 163. These correspond to the categories 117, 119, 121. In the non-limiting example in FIG. 2, the histograms run from Mar. 7, 2013, as seen at 159, to Mar. 7, 2014, as seen at 161. Contracts that expire on or beyond Mar. 7, 2014 extend the full width. Contracts that expire before Mar. 7, 2014 extend less than the full width. Other approaches could be used in other embodiments; for example, the bars could be scaled such that only contracts with the longest-in-the-future expiration date extended the full width.

FIG. 3 shows the result of hovering on one of the histograms 169. Window 171 opens to advise of the end date of Apr. 13, 2013.

FIG. 4 shows the result of hovering on one of the note flags 173. Window 175 opens to advise that despite the indicated end date of Apr. 13, 2013, the customer's end date is Jun. 3, 2016 through sales order number 6/3/16. In some instances, a further visual indication may be provided to draw the user's attention to anomalous conditions in the “Notes” column 151; for example a red or other brightly colored flag may be displayed, an exclamation point may be displayed, the letter “Y” may be in a bright or unusual color, and so on.

Hovering on the entry TAU 157 as discussed above, though not expressly illustrated, is similar to the scenarios depicted in FIGS. 3 and 4.

FIG. 5 shows the screen displayed when the user clicks on “ALPHA CORPORATION” in column 135 of FIG. 2. The company that is the subject of the MSA, here, “ALPHA CORPORATION,” is shown at 201; at 203, the corresponding category (e.g., 109, 111, or 113) is displayed. A first column 211 list all the orders for entity 201; a second column 213 lists the initial MRR (similar to order MRR 139); a third column 215 lists the active MRR (similar to active MRR 143); a fourth column 217 lists the implementation date; and a fifth column 219 lists the cancel date. Any one, some or all of the columns 211-219 can include up-down sort arrows 221, 223, 225, 227, 229 which allow the corresponding column to be sorted in increasing or decreasing order alphabetically, numerically, or otherwise, as the case may be.

Implementation date 217 is the date order the order was implemented and the customer began to receive services and/or goods; it is typically different than the order date, which is the date the order was placed.

Furthermore in this regard, many customers might have a significant number of sales orders; say, on the order of 15-20 sales orders, with an underlying MSA. The end date might not be clear because of the many different orders. In one or more embodiments, a continuous audit process is carried out in an automated fashion, so as to avoid duplication of effort; refer to discussion of FIG. 13 below.

Clicking on “ALPHA CORPORATION” 201 leads the user to the screen shown in FIG. 16 wherein the user can add notes (in space 357) regarding, e.g., anomalies in the contract. For example, there may be a default rule that contracts are extendable. However, one anomaly that might arise is a stand-alone order that does not extend the term of the agreement. See discussion of FIG. 4; message 175 may refer to such a stand-alone order having an end date later than that for the MSA. In FIG. 16, the entity name is shown at 353 and the MSA name is shown at 355. The user types the pertinent notes in field 357 and clicks “submit” button 359. This causes the corresponding record in database 1304 to be updated such that a “Y” appears in column 151 of FIG. 4 and the notes types in box 357 appear in box 175 when the user hovers his or her pointing device on the “Y.” Status buttons 361 can be manually selected or de-selected to indicate the reliability of the data as shown at 109, 111, 113 in FIG. 1. On this screen, the legal reviewer can set the status as desired. In contrast, elements 117, 119, 121 are used during the search process to limit results by only those records which carry the desired status.

Note that any of the editing processes depicted herein could also be used for the initial creation of entries. Note also that the number of entries or hits on the various screens is limited in number for illustrative convenience, but there may be hundreds or thousands of entries, for example, in one or more embodiments.

The “Recalculate Customer Orders” link 205 leads the user to the screen shown in FIG. 12. This link is useful, for example, for system updaters. The “Create New MSA” link 209 exists in the case there is more than one governing agreement with the customer. Since this system groups orders together into a collection which are in turn governed by the MSA, this allows the case where a “customer” could have 2 or more agreements in place, each which governs a subset of their orders.

FIG. 6 shows the screen that results when clicking the link for the first order “MM-9506601-1” in FIG. 5. The title of this screen is “Sales Order Detail Edit,” as seen at 265. The depicted information includes business name 237, order number 239, and order date 241. The entity name associated with the MSA is shown at 243; the implementation date at 249; the initial order term in months at 251; the renewal term in months at 253; and the cancellation notice window in days at 255. Furthermore, the end date is shown at 257; the cancellation date at 259, and whether the order is a stand-alone order at 261. Desired changes are made to any of the editable fields, and then update button 263 is clicked to save the changes. Fields 251, 253, 255, 257, and 259 are depicted as locked from editing in this non-limiting example.

FIG. 7 shows the screen that results when clicking the link 235 for “Change History” in FIG. 6. The customer is listed at 271 and the order number is displayed at 273. The “governing order” 289 refers to an order that governs most or all of the customer's individual orders. More particularly, the Governing Sales Order is the sales order that governs the term of the Agreement; i.e., the original sales order or an order that extends the then-current term. Column 275 shows the renewal date; column 277 shows the initial term in months; column 279 shows the end date; column 281 shows the renewal term in months; column 283 indicates whether the order is stand alone; column 285 shows the cancellation notice window in days; column 287 shows the cancellation date; column 289 shows the governing order number; and column 291 shows the “last modified by” information. In the case the system automations performing updates on the scheduled nightly run (nightly.py), or if altered by a reviewer/system updater it would carry their username here instead of the system process which last updated. Each row represents details about the particular sales order 273 at different points in time. Note that the governing order changes in the second row of column 289 as the initial order becomes subject to a new governing order.

FIG. 8 shows the screen that results when clicking the link 207 for “histogram” in FIG. 5. The histogram function provides a visual indication of the status of contracts and/or work orders. In one or more embodiments, contracts are extensible in nature. The concept of a governing order 295 has been discussed above with regard to column 289 in FIG. 7. The entity associated with the MSA is shown at 293; the governing order is shown at 295; the end date is shown at 297; the renewal term is shown at 299, and the cancellation window is shown at 301. A color-coded histogram 303, 305 is shown for each individual order. The histograms may be configured, for example, as discussed above with regard to 163 in FIG. 2; except that they are displayed for each order instead of the MSA as a whole. Alternatively, different colors and/or scaling could be used for the individual order histograms.

FIG. 9 shows a listing of non-implemented orders, i.e., orders that have been executed but where the customer has not yet received services. This screen may be reached, for example, by clicking on link 129 in FIG. 1, with optional filtering. A first column 307 shows the customer name; a second column 309 shows the order number; and a third column 311 shows the date of the last installation. “Last Install” in this context is the most recent date of any installed line item of the sales order. A sales order is not considered “fully implemented” (and hence does not receive an order-level implementation date) until either a system updater manually enters a date via FIG. 6 field 249, or the system process identifies that a predetermined amount (by way of a non-limiting example, 90%) of the MRR is installed. As a result, and order with some line items installed, but less than 90% (or other predetermined amount) of MRR installed, can be both non-implemented but also have a “last install” date. Any one, some or all of the columns 307-311 can include up-down sort arrows 313, 315, 317 which allow the corresponding column to be sorted in increasing or decreasing order alphabetically, numerically, or otherwise, as the case may be.

FIG. 10 shows a listing of orders pending legal review. This screen may be reached, for example, by clicking on link 131 in FIG. 1, with optional filtering. A first column 319 shows the customer name; a second column 321 shows the order number; a third column 323 shows the percentage of the MRR that has actually been installed; a fourth column 325 shows the order date; and a fifth column 327 shows the implementation date. Any one, some or all of the columns 319-327 can include up-down sort arrows 329, 331, 333, 335 which allow the corresponding column to be sorted in increasing or decreasing order alphabetically, numerically, or otherwise, as the case may be. Other columns could be provided with sort arrows if desired.

FIG. 11 depicts a screen with the results of a search using the contract automation tool of FIG. 1. In this instance, the term “CONNECTICUT” was entered into box 123 and “FIND” button 125 was clicked without selecting any of the status filters 117, 119, or 121. The results yield four hits shown at 337. Each hit has the corresponding status indicator 109, 111, or 113 displayed to its left. In some instances, additional options or wild card functionality can be provided to allow searching for exact hits, hits that contain the search term, and so on.

FIG. 12 depicts a sales order reset screen reached by selecting the “Recalculate Customer Orders” link of FIG. 5. At 339, the user is reminded of the consequences of proceeding; he or she then proceeds by clicking button 341 or cancels by clicking button 343.

By way of review, one significant advantage of one or more embodiments is the ability to rapidly visualize and determine the contract end date. Pertinent features of one or more embodiments include displaying and/or sorting on MRR, contract end date sorting, and display of individual customer account end dates.

Some embodiments allow the user to access a customer's invoice as a PDF or other file type and/or to conduct a search of a customer's records for invoices. In one approach, the contract automation module per se does not provide access to customer invoices. Customer invoices are available to properly authorized staff via a different functional module within the same portal where the contract automation tool is presented.

One or more embodiments provide a “waterfall” feature for financial details and contract end dates of all customers; that is to say, an illustrative option which allows the user to easily view a large aggregation of data. See, e.g., FIGS. 2-4.

In one or more embodiments, each customer page (e.g. FIG. 5) includes a histogram feature 207 for customer contract end dates, as seen in FIG. 8, particularly useful for complex extensible or fluid contracts that may have unique provisions or terms and/or multiple amendments. This tracking feature of contract end dates can be automated to reduce required employee-system interaction and/or to constantly track changes to the contract, which reduces administrative time and costs. Automation can also include the automatic renewal of a customer contract and any extension or update as well.

One or more embodiments provide the capability to sort all of an organization's monthly recurring revenue by highest to lowest or lowest to highest; e.g., using arrows 141, 145. Further, one or more embodiments provide the capability to sort by the longest contract commitment or the shortest contract commitment (e.g., using arrows 149). This data can then be viewed together as an intangible tool for mergers and acquisitions, debt or equity financing, and/or an overall management tool for forecasting commitments and recurring revenue trends year-over-year.

In one or more embodiments, the tool also has a search function (see FIG. 1) to find any customer in the corporate database.

In some cases, a notation feature (see FIGS. 4 and 16) is provided for unique and/or anomalous contract terms.

In one or more embodiments, the tool is partially or completely automated, with limited oversight needed once the script is written for the unique business model. In some instances, a nightly automation process updates the database for ease of use and to increase the reliability of the data. The nightly scripts are a scheduled execution of the contract engine 1308. The engine is invoked nightly across all orders, but can also be invoked manually via FIG. 12/341 as described above. The updates are made to the data in database 1304. In a non-limiting example, the engine 1308 is at least partially implemented in the Python scripting language.

In some instances, as seen in FIG. 13, the system can also be synchronized with the corporate database(s) so that updates in attendant systems can automatically update the tool for cross-departmental and cross-functional automation greatly reducing costs and increasing efficiency for contract administration and management.

In one or more embodiments, in addition to the automation defined and implemented by the nightly processing scripts, an exception handling capability is provided, which allows for contract administrators to override default behaviors in accordance with language that may be present in subsequent sales orders. Examples include sales orders which should not be governed by an existing MSA, or sales orders which should exist in a standalone capacity.

One or more instances are useful, for example, in order to allow internal departments and employees of an organization to easily visualize multiple types of data sets, such as, for example, contract end dates, financial data, and/or salient contract terms and conditions for the entire customer base of an organization with complex contract terms and conditions.

One or more embodiments are believed to be particularly useful in cases when contracts are extensible, fluid and constantly changing, inasmuch as it is inefficient to complete a contract review over and over when it can be automated—including subsequent changes to the pertinent contracts. One or more instances advantageously reduce the requirement for continued review of the same contract, because the system tracks the history and/or any modifications. In one or more embodiments, human validation is only employed when needed, and the main contract terms are easily accessible and retrievable without pulling multiple lengthy contract sets. Further, when the organization that utilizes the tool desires to conduct a business transaction and/or track financial commitments and/or long-term revenue, the pertinent information can be tracked from the inception of the customer or client intake and changes can be tracked throughout the relationship, greatly reducing the many personnel hours needed for inefficient manual review of the data. This aspect can be useful, for example, in the event of a business transaction (e.g., merger) or in connection with other financial reporting needs of a business.

In a non-limiting example, the tool is implemented as one or more distinct software modules, as a modular component within a larger software system. In some instances, underlying tools make use of open source operating systems or languages such as LINUX, Python, and the like, and/or commercial products such as ORACLE database software. In some cases, an integrated overall system includes a collection of functional modules, of which the contract automation tool is one, exposed to authorized staff in a web portal. This portal and the supporting background processes (engines, nightly jobs, and the like) comprise at least portions of the larger system.

FIG. 13 shows a block diagram of an exemplary system, in accordance with an aspect of the invention. Server 1302 includes one or more computer systems, such as shown and discussed with respect to FIG. 14, discussed below. Server 1302 is coupled to a contract database 1304 including a non-volatile memory (e.g., a hard disk drive) which stores a plurality of records as described elsewhere herein. Server 1302 executes a number of distinct software modules 1306, 1308, 1310, 1312 which are stored in a non-transitory storage medium or multiple such media. User interface module 1306 creates the screens depicted in the figures; for example, by serving out html code to one or more clients 1316 over Internet 1314. The clients include browser software which executes the html to cause the screens in the figures to be displayed on a display of client 1316, and to obtain user inputs as described herein. FIG. 14 is also indicative of the general architecture of client 1316. The web-based solution of FIG. 13 is a non-limiting example and other techniques could be used to provide user access in other cases; for example, over a network connection other than the Internet (e.g., an internal network), via terminal access to a mainframe instead of a server, and so on.

Database module 1310 formulates queries to the records in database 1304, using, for example, structured query language (SQL) or the like.

External program interface module 1312 interfaces with one or more external programs 1318-1, 1318-2, . . . 1318-n and or one or more external databases 1320-1, 1320-2, . . . 1320-n. The external programs and/or external databases may reside on the same physical server 1302 as the modules 1306, 1308, 1310, 1312 or may reside on a different physical and/or logical server or other computer. These may include, for example, accounting system having invoice data, an order entry system, or the like; in general, the external programs and/or databases may represent the same or different departments and/or functional areas as the contracts database. For example, database 1304 might be under the control of the legal department and may interface with systems from the sales, marketing, or accounting departments. Thus, server 1302 and database 1304 can interface with other systems pertaining to new order intake, order updating, and so on.

Contract engine module 1308, in one or more embodiments, audits the external programs and/or external databases (e.g., via one or more suitable application program interfaces (APIs)). Such audits may be continuous or on a batch (e.g., nightly) basis. Such audits may detect, for example, that an order entry system has recorded a new order or a change to an existing order. If the new order has an end date after the current contract end date, engine 1308 may automatically update the end date on database 1304. In some instances, the logic applied by engine 1308 may be specified in a suitable scripting language (e.g., Python, Perl) or the like.

### Exemplary Database Record/Contract Automation Date Requirements

Database 1304 includes suitable records for each customer MSA; namely, status 109, 111, 113; total order MRR; total active MRR; customer name; overall end date; optionally, any notes (see, e.g., discussion with regard to elements 173, 175); and optionally, any legacy organization data. Further, for each individual order number, the records include initial MRR, active MRR, implementation date, and cancellation date. These are examples; in general, records can be provided for all of the data items shown in the figures.

In one or more embodiments, the MSA Effective Date is defined as outlined in each applicable MSA; for example, as the latest dated signature by either the customer or the good or service provider. This can be added, for example, by a team of human operators (e.g., using one or more programs 1318) responsible for “loading” orders into the overall system (including as they are managed in the tool). Preferably, there is a set of processes in place to ensure billing dates and the like are properly managed.

In at least some cases, the MSA End Date is derived from the farthest ending, then existing, service order or schedule; provided the schedule or sales order extends beyond the then-current term. In some cases, the Contract Term is added by the above-mentioned team of human operators (e.g., using one or more programs 1318).

Typically, the Sales Order Effective Date is on the sales order and can be passed in to the system.

The Sales Order Fully Implemented Date is the date that the customer is notified that the goods or services are installed and ready for use.

The Sales Order End Date, in one or more embodiments, is derived from each sales order's fully implemented date; plus the number of months outlined in each such sales order; plus any applicable renewal terms outlined in the MSA that have occurred; plus any other renewal(s) due to subsequent sales order(s) that extend the term of such existing sales order(s) (assuming there is no hard-stop term defined in the sales order) including any subsequent renewals.

In some instances, the automated rules to determine the governing order, and the implied “pull out” of existing orders when a new governing order is loaded, are a default to which exceptions are permitted in appropriate cases. To that end, in one or more embodiments, the tool allows orders to be identified as “stand alone” and have the dates managed manually. This allows the system to provide automation in the common case, but also accommodate the “one offs” which invariably are part of large, complex, long-lived customer relationships. In view of this, if a customer requests two sales orders to have identical end dates and the customer does not want the contract to be pulled out by the subsequent sales order, but rather the Customer wants the sales order to have the same term end date as a preceding order, then in such case, one has to identify the preceding sales order number that has the governing term end date for both sales orders and adjust the months of the term in the sales order accordingly.

In one or more embodiments, if blank, the value for the Customer Inception Date can be taken as the MSA Start Date.

As noted, the Governing Sales Order is the sales order that governs the term of the Agreement; i.e., the original sales order or an order that extends the then-current term. A Stand Alone Sales Order is a sales order that does not govern the term or extend the term at the time of execution.

In one or more embodiments, the sales order displays a field to define whether the order is add-on, replacement, renewal, or trial.

By way of a non-limiting example, consider a first sales order; namely, Sales Order 1. The same has an MSA Start date of Oct. 1, 2008, a Sales Order date of Oct. 1, 2008, a fully implemented date of Nov. 1, 2008, and a term of 24 months. The effect is to result in an MSA End date of Oct. 31, 2010 and a Sales Order end date of Oct. 31, 2010.

Now consider a second sales order; namely, Sales Order 2. The same has a Sales Order date of Dec. 1, 2008, a fully implemented date of Feb. 1, 2009, and a term of 24 months. The effect is to result an MSA End date of Jan. 31, 2011, a Sales Order 1 end date of Jan. 31, 2011, and a Sales Order 2 end date of Jan. 31, 2011.

Finally, consider a third sales order; namely, Sales Order 3. The same has a Sales Order date of May 1, 2009; a fully implemented date of Jun. 1, 2009; and a term of 4 months. The effect is to result in an MSA End date of Jan. 31, 2011; a Sales Order 1 end date of Jan. 31, 2011; a Sales Order 2 end date of Jan. 31, 2011; and Sales Order 3 end date of Sep. 30, 2009.

Further examples are shown in FIG. 17, which shows exemplary sales orders in spreadsheet form, and the effect of new orders on pertinent parameters. In a first scenario 1702, there are five exemplary customer sales order numbers shown in first column 1706. The date of implementation is shown in column 1708 for each sales order. Columns 1710-1724 permit visualization of the sales order term. In particular, column 1710 shows a one-month term; column 1712 a two-month term; column 1714 a three-month term; column 1716 a six-month term; column 1718 a twelve-month term; column 1720 a twenty-four month term; column 1722 a thirty-six month term; and column 1724 a forty-eight month term. Column 1727 shows the end date of the sales order or agreement. Each term may have a characteristic color and each row may have a bar histogram in the appropriate color extending from the left edge of column 1710 to the appropriate place. For example, in the first scenario 1702, sales order #11111 has an implementation date of Jan. 1, 2008 and an agreement end date of Dec. 31, 2011. It has a 36 month term and its histogram bar extends from the left side of column 1710 to the right side of column 1722; it has the same color as the “36 Months” column heading.

Sales order #22222 in the first scenario has an implementation date of May 5, 2009 and an agreement end date of May 4, 2013. It has a 48 month term and its histogram bar extends from the left side of column 1710 to the right side of column 1724; it has the same color as the “48 Months” column heading. The agreement is thus extended to May 4, 2013 including Sales Order #11111.

Sales order #33333 in the first scenario has an implementation date of Jul. 4, 2009 and a 3 month term; its histogram bar extends from the left side of column 1710 to the right side of column 1714; it has the same color as the “3 Months” column heading. This Sales Order thus ends and/or renews as of Oct. 3, 2009.

Sales order #44444 in the first scenario has an implementation date of Dec. 9, 2009 and a 12 month term; its histogram bar extends from the left side of column 1710 to the right side of column 1718; it has the same color as the “12 Months” column heading. This Sales Order thus ends and/or renews as of Dec. 8, 2010.

Sales order #55555 in the first scenario has an implementation date of Jul. 8, 2009. It has a 48 month term and its histogram bar extends from the left side of column 1710 to the right side of column 1724; it has the same color as the “48 Months” column heading. This Sales Order extends all outstanding orders and the Agreement is due to end on Jul. 7, 2013.

In a second scenario 1704, sales order #11111 has an implementation date of Dec. 1, 2008 and an agreement end date of Nov. 30, 2010. It has a 24 month term and its histogram bar extends from the left side of column 1710 to the right side of column 1720; it has the same color as the “24 Months” column heading.

Sales order #22222 in the second scenario has an implementation date of Jan. 3, 2009 and a one month term; its histogram bar extends from the left side of column 1710 to the right side of column 1710. It has the same color as the “1 Month” column heading. This Sales Order thus ends and/or renews as of Feb. 2, 2009.

Sales order #33333 in the second scenario has an implementation date of Feb. 5, 2009 and a 6 month term; its histogram bar extends from the left side of column 1710 to the right side of column 1716; it has the same color as the “6 Months” column heading. This Sales Order thus ends and/or renews as of Aug. 4, 2009.

Sales order #44444 in the second scenario has an implementation date of Mar. 5, 2009 and a 12 month term; its histogram bar extends from the left side of column 1710 to the right side of column 1718; it has the same color as the “12 Months” column heading. This Sales Order thus ends and/or renews as of Mar. 4, 2010.

Sales order #55555 in the second scenario has an implementation date of Apr. 5, 2009. It has a one month term and its histogram bar extends from the left side of column 1710 to the right side of column 1710; it has the same color as the “1 Month” column heading. This Sales Order thus ends and/or renews as of May 4, 2009.

As shown at 1728, in a non-limiting example, if a new sales order extends beyond the current term of the customer's MSA, the current term of the customer's MSA, including all outstanding sales orders, is deemed to be amended to expire on the date the new sales order expires, subject to renewal according to the customer's MSA. This rule can be encoded in engine 1308 and applied during continuous or periodic updating processes as described elsewhere herein. Please note that the rule and wording depicted is but one embodiment. Other wording and rules could be used in other embodiments; for example, 1728 could read as follows: “This Sales Order shall be effective as of the latter-dated signature below, and the term of this Sales Order shall be 12 months commencing on the Fully Implemented Date, subject to renewal in accordance with the Agreement. If upon the effective date of this Sales Order it extends beyond the current term of the Agreement (as defined in the Master Services Agreement), the current term of the Agreement, including all outstanding Schedules and Sales Orders, shall be deemed to be amended to expire on the date this Sales Order expires, and the Agreement shall renew for successive automatic renewal terms equal to the term of this Sales Order.”

Recapitulation

Given the discussion thus far, it will be appreciated that, in general terms, an exemplary method, according to an aspect of the invention, includes the step of maintaining, on a persistent storage device, a database 1304 of contracts. The database has at least one record for each of the contracts. The at least one record for each of the contracts includes at least one field including a corresponding contract end date (see, e.g., column 147 in FIG. 2). This step could be carried out, for example, with database module 1310. An additional step includes obtaining, at a computer processor (e.g., processor 1420 of a server 1302) in communication with the persistent storage device, at least one user query (for example, user enters a search term in box 123, with or without filtering, or clicks on one of the links 127, 129, 131). This step could be carried out, for example, with user interface module 1306. A further step includes, responsive to the at least one user query, generating, with the computer processor, a signal to cause a display device (e.g., display 1440 of a client 1316) to display a histogram of the corresponding contract end date for at least one of the contracts. This step could be carried out, for example, by user interface module 1306 serving html to the client 1316 over Internet 1314. See, e.g., FIG. 2.

For the avoidance of doubt, it is worth noting that the notation “a database 1304 of contracts” is employed for brevity. Of course, an electronic database is contemplated and it does not contain physical paper contracts. Also, the text of the contracts per se may or may not be in the database along with the various fields of the records.

In some embodiments, an additional step includes maintaining, on the persistent storage device, in the database of contracts, at least a second field for each of the records for each of the contracts. The at least second field includes contract monthly recurring revenue. An even further step in such embodiments includes, responsive to the at least one user query, generating, with the computer processor, a signal to cause the display device to display the contract monthly recurring revenue for at least one of the contracts. See, e.g., columns 139, 143. In at least some such embodiments, the computer processor generates a signal to cause the display device to display the contract monthly recurring revenue for a plurality of additional ones of the contracts. Optionally, responsive to the at least one user query, the computer processor generates a signal to cause the display device to display the contract monthly recurring revenue for the at least one of the contracts and for the plurality of additional ones of the contracts, as a ranked list sorted by the monthly recurring revenue. See discussion of elements 141, 145.

Optionally, responsive to the at least one user query, the computer processor generates a signal to cause the display device to display a histogram of the corresponding contract end date for at least another one of the contracts. As seen in FIG. 2, in some cases, the histograms are bars having different lengths corresponding to different contract end dates. Optionally, the histograms are color coded; color-coded histograms could be bars or could have different shapes, and may or may not have different sizes depending on their end dates.

In some cases, additional steps include, responsive to the at least one user query, generating, with the computer processor, a signal to cause the display device to display a list having a plurality of entries corresponding to at least a portion of the contracts; and, responsive to the at least one user query, generating, with the computer processor, a signal to cause the display device to display the list as a ranked list sorted by the corresponding contract end dates. See discussion of arrows 149. Note that “at least one user query” could include, for example, an initial query as discussed above to cause the screen of FIG. 2 to be displayed, followed by a second query in the form of clicking on arrow 149.

In some cases, the contracts (e.g., master services agreements) have sales orders associated with them. Thus, in some cases, additional steps include maintaining, on the persistent storage device, in the database of contracts, a plurality of additional fields for at least some of the contracts, the plurality of additional fields for the at least some of the contracts including fields including data for individual sales orders; and, responsive to the at least one user query, generating, with the computer processor, a signal to cause the display device to:
display histograms of the data for the individual sales orders (see, e.g., FIG. 8) and/or
display a list having a plurality of entries corresponding to at least a portion of the sales orders (in this case, responsive to the at least one user query, the computer processor generates a signal to cause the display device to display the list as a ranked list sorted by corresponding sales order monthly recurring revenue—see, e.g., FIG. 5).

As noted, some embodiments interface with external applications; through such interfacing, update data can be obtained for the end dates of at least a portion of the contracts. This data can be used to update the database 1304.

In some cases, the update data is data indicative of at least one new sales order for at least one of the contracts. In such cases, the at least one field including the corresponding contract end date for the at least one of the contracts is updated by extending same to reflect the end date of the at least one new sales order. This step can be carried out, for example, with contract engine software module 1308 embodied on a non-transitory storage medium and executing on the computer processor. The contract engine software module has encoded therein a default rule to extend the corresponding contract end date to reflect the end date of the at least one new sales order.

In some cases, in the database 1304, at least a second field is maintained for each of the contracts; this field includes an indication of a corresponding governing sales order. This indication is updated to an identifier of the at least one new sales order. Recall that the Governing Sales Order is the sales order that governs the term of the Agreement; i.e., the original sales order or an order that extends the then-current term.

As noted, in some instances, an input indicative of an operator override of the default rule might be obtained for another one of the contracts; in response, the end date is not updated for that contract.

In some cases, the update data is data indicative of at least one replacement contract for at least one of the contracts (e.g., a new MSA). When a new MSA is entered, the contract end date for the at least one of the contracts is extended to reflect the end date of the at least one replacement contract. This step can be carried out, for example, with contract engine software module 1308 embodied on a non-transitory storage medium and executing on the computer processor. The contract engine software module has encoded therein a default rule extend the corresponding contract end date to reflect the end date of the replacement contract.

As noted, one or more embodiments utilize reliability indicators such as 109, 111, 113. Thus, some embodiments include maintaining, on the persistent storage device, in the database of contracts, at least a second field for each of the contracts. The at least second field includes review-based reliability status (e.g., reliable; new order loaded so don't rely; not reviewed by legal so don't rely) for a corresponding one of the contracts. In some cases, responsive to the at least one user query, a signal is generated with the computer processor to cause the display device to display the reliability status for a plurality of the contracts. See, e.g., first column in FIG. 2.

In an alternative embodiment, referring to FIG. 18, different reliability status indicators can be used. For example, wherever status 109 appears in the other figures, status indicator 1809, an “OK” button with a “happy face” emoticon can be used; wherever status 111 appears in the other figures, status indicator 1811, a button with a triangle enclosing an exclamation point can be used; and/or wherever status 113 appears in the other figures, status indicator 1813, an octagonal outline enclosing the word STOP (like a traffic stop sign) can be used. Thus, some embodiments include generating, with the computer processor, a signal to cause the display device to display the letters OK and a happy face emoticon for those of the plurality of contracts for which the corresponding contract end date can be relied upon; and generating, with the computer processor, a signal to cause the display device to display an octagonal outline enclosing the word STOP for at least a portion of those of the plurality of contracts for which the corresponding contract end date cannot be relied upon, based upon the update data.

In another aspect, an exemplary method includes maintaining, on a persistent storage device, a database of contracts 1304. The database has at least one record for each of the contracts, and the at least one record for each of the contracts includes at least one field comprising a review-based reliability status. See, e.g., the first column in FIG. 2 with elements 109, 111, 113. An additional step includes obtaining, from an external application 1318, at at least one computer processor in communication with the persistent storage device (e.g., processor of server 1302), updated data comprising at least one of a new contract and a change to an existing one of the contracts (e.g., a new work order). A further step includes updating, in the database 1304 on the persistent storage device, the at least one field comprising the review-based reliability status for one of the existing contracts or the new contract, as the case may be. A further step includes, responsive to at least one user query, generating, with the computer processor, a signal to cause a display device to display the updated field comprising the review-based reliability status for the one of the existing contracts or the new contract, as the case may be. See, e.g., the first column in FIG. 2 with elements 109, 111, 113; for example, color-coded indicator of reliability 109, 111, 113 for the contract in question would change.

As with other methods disclosed herein, an optional additional step includes providing a system, wherein the system comprises distinct software modules. Each of the distinct software modules is embodied on a non-transitory computer-readable storage medium, and the distinct software modules comprise a database module 1310, a contract engine module 1308, a user interface module 1306, and an external program interface module 1312. The maintaining of the database of contracts is carried out by the database module executing on the computer processor. The obtaining of the updated data is carried out by the external program interface module executing on the computer processor. The updating is carried out by the contract engine module executing on the computer processor. The generating, with the computer processor, of the signal to cause the display device to display the updated field is carried out, at least in part, by the user interface module executing on the computer processor.

In still another aspect, an exemplary method includes maintaining, on a persistent storage device, a database of contracts 1304. The database has at least one record for each of the contracts. The at least one record for each of the contracts includes at least one field comprising implementation date. See, e.g., column 217 in FIG. 5. Additional steps include obtaining, at a computer processor in communication with the persistent storage device (e.g., processor of server 1302), at least one user query; and, responsive to the at least one user query, generating, with the computer processor, a signal to cause a display device to display a list comprising at least a portion of the contracts for which the implementation date field is blank. See FIG. 9, obtained by clicking 129 in FIG. 1 (user query).

This method can be optionally combined with one or more of the other methods described herein.

An optional additional step includes obtaining pertinent external data from 1318 and/or 1320.

In some cases, additional steps include determining that at least one of the contracts for which the implementation date field is blank has had a predetermined amount of monthly recurring revenue installed; and, responsive to determining that the at least one of the contracts for which the implementation date field is blank has had the predetermined amount of monthly recurring revenue installed, automatically populating the implementation date field with a date on which the predetermined amount of monthly recurring revenue has been installed. These steps could be carried out, for example, by logic in contract engine module 1308, based on querying database 1304 with database module 1310. In a non-limiting example, the predetermined amount of monthly recurring revenue comprises ninety percent of total monthly recurring revenue.

As with other methods disclosed herein, an optional additional step includes providing a system, wherein the system comprises distinct software modules. Each of the distinct software modules is embodied on a non-transitory computer-readable storage medium, and the distinct software modules comprise a database module 1304 and a user interface module 1306. A further step includes querying the database 1304 based on the at least one user query. The maintaining of the database of contracts is carried out by the database module executing on the computer processor. The obtaining of the at least one user query is carried out by the user interface module executing on the computer processor. The querying of the database based on the at least one user query is carried out by the database module executing on the computer processor. The generating, with the computer processor, of the signal to cause the display device to display the list is carried out, at least in part, by the user interface module executing on the computer processor. For example, module 1310 searches database 1304 for records with a blank implementation date field and module 1306 facilitates display based on no implementation date being present.

Also contemplated are systems and/or apparatuses including database 1304, one or more appropriate ones of the modules 1306, 1308, 1310, 1312, and optionally one, some, or all of the additional components shown in FIG. 13 or their alternatives (e.g., internal network instead of Internet 1314; mainframe or other computing device instead of server 1302; terminal or other computing device instead of client 1316.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). The means do not include transmission media per se or disembodied signals per se. Appropriate interconnections via bus, network, and the like can also be included.

FIG. 14 is a block diagram of a system 1400 that can implement at least some aspects of the invention, and is representative, for example, of the servers, client computers, and the like shown in the figures. As shown in FIG. 14, memory 1430 configures the processor 1420 to implement one or more methods, steps, and functions (collectively, shown as process 1480 in FIG. 14) described herein. The memory 1430 could be distributed or local and the processor 1420 could be distributed or singular. Different steps could be carried out by different processors.

The memory 1430 could be implemented as an electrical, magnetic or optical memory, or any combination of these or other types of storage devices. It should be noted that if distributed processors are employed, each distributed processor that makes up processor 1420 generally contains its own addressable memory space. It should also be noted that some or all of computer system 1400 can be incorporated into an application-specific or general-use integrated circuit. For example, one or more method steps could be implemented in hardware in an ASIC rather than using firmware. Display 1440 is representative of a variety of possible input/output devices (e.g., keyboards, mice, and the like). Every processor may not have a display, keyboard, mouse or the like associated with it. Furthermore in this regard, examples have been given herein of clicking and/or hovering with a mouse, but these are non-limiting and other approaches can be used in other cases; for example, other pointing devices can be used; a touch-screen can be used; arrow keys can be used, and so on.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system (including, for example, system 1400 or the like), to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). As used herein, a tangible computer-readable recordable storage medium is defined to encompass a recordable medium, examples of which are set forth above, but is defined to exclude a transmission medium or disembodied signal.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include one or more computer programs comprising computer program code means adapted to perform one or all of the steps of any methods or claims set forth herein when such program is run, for example, on the server 1302; client computer 1316, or the like, and that such program may be embodied on a tangible computer readable recordable storage medium. As used herein, including the claims, a “server” includes a physical data processing system (for example, system 1400 as shown in FIG. 14) running a server program. It will be understood that such a physical server may or may not include a display, keyboard, or other input/output components.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures (e.g. software components of FIG. 13). For example, web clients 1316 include browser programs downloading html into the browser. Software modules can include the browser(s) and the html to be downloaded to the browser(s). Software modules can be provided to implement modules 1306, 1308, 1310, 1312, as well as programs 1318-1 through n, on the same or different physical machines, optionally with virtualization. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method comprising the steps of:
maintaining, on a persistent storage device, a database of contracts, said database having at least one record for each of said contracts, said at least one record for each of said contracts including at least one field comprising a corresponding contract end date;
obtaining, at a computer processor in communication with said persistent storage device, at least one user query; and
responsive to said at least one user query, generating, with said computer processor, a signal to cause a display device to display a histogram of said corresponding contract end date for at least one of said contracts.

2. The method of claim 1, further comprising:
maintaining, on said persistent storage device, in said database of contracts, at least a second field for each of said records for each of said contracts, said at least second field comprising contract monthly recurring revenue; and
responsive to said at least one user query, generating, with said computer processor, a signal to cause said display device to display said contract monthly recurring revenue for at least one of said contracts.

3. The method of claim 2, further comprising, responsive to said at least one user query, generating, with said computer processor, a signal to cause said display device to display said contract monthly recurring revenue for a plurality of additional ones of said contracts.

4. The method of claim 3, further comprising, responsive to said at least one user query, generating, with said computer processor, a signal to cause said display device to display said contract monthly recurring revenue for said at least one of said contracts and for said plurality of additional ones of said contracts, as a ranked list sorted by said monthly recurring revenue.

5. The method of claim 1, further comprising, responsive to said at least one user query, generating, with said computer processor, a signal to cause said display device to display a histogram of said corresponding contract end date for at least another one of said contracts.

6. The method of claim 5, wherein said contract end date for said at least one of said contracts and said contract end date for said at least another one of said contracts are different, and wherein said generating of said signal to cause said display device to display said histograms comprises generating, with said computer processor, a signal to cause said display device to display a bar having a first length corresponding to said contract end date for said at least one of said contracts and a bar having a second length corresponding to said contract end date for said at least another one of said contracts.

7. The method of claim 5, wherein said contract end date for said at least one of said contracts and said contract end date for said at least another one of said contracts are different, and wherein said displaying of said histograms comprises:
generating, with said computer processor, a signal to cause said display device to display said histogram of said corresponding contract end date for said at least one of said contracts as a histogram of a first color indicative of said corresponding contract end date for said at least one of said contracts; and
generating, with said computer processor, a signal to cause said display device to display said histogram of said corresponding contract end date for said at least another one of said contracts as a histogram of a second color indicative of said corresponding contract end date for said at least another one of said contracts.

8. The method of claim 1, further comprising:
responsive to said at least one user query, generating, with said computer processor, a signal to cause said display device to display a list having a plurality of entries corresponding to at least a portion of said contracts; and
responsive to said at least one user query, generating, with said computer processor, a signal to cause said display device to display said list as a ranked list sorted by said corresponding contract end dates.

9. The method of claim 1, further comprising:
maintaining, on said persistent storage device, in said database of contracts, a plurality of additional fields for at least some of said contracts, said plurality of additional fields for said at least some of said contracts including fields comprising data for individual sales orders; and
responsive to said at least one user query, generating, with said computer processor, a signal to cause said display device to display histograms of said data for said individual sales orders.

10. The method of claim 9, further comprising:
responsive to said at least one user query, generating, with said computer processor, a signal to cause said display device to display a list having a plurality of entries corresponding to at least a portion of said sales orders; and
responsive to said at least one user query, generating, with said computer processor, a signal to cause said display device to display said list as a ranked list sorted by said corresponding sales order monthly recurring revenue.

11. The method of claim 1, further comprising:
obtaining, from an external application, update data for said end dates of at least a portion of said contracts; and
updating, in said database on said persistent storage device, said at least one field comprising said corresponding contract end date for said at least a subset of said portion of said contracts.

12. The method of claim 11, wherein said update data comprises data indicative of at least one new sales order for at least one of said contracts, further comprising updating said at least one field comprising said corresponding contract end date for said at least one of said contracts by extending same to reflect an end date of said at least one new sales order, with a contract engine software module embodied on a non-transitory storage medium and executing on said computer processor, said contract engine software module having encoded therein a default rule to extend said corresponding contract end date to reflect said end date of said at least one new sales order.

13. The method of claim 12, further comprising:
maintaining, on said persistent storage device, in said database of contracts, at least a second field for each of said contracts, said at least second field for each of said contracts comprising an indication of a corresponding governing sales order; and
updating said at least one field comprising said indication of said corresponding governing sales order for said at least one of said contracts by replacing same with an identifier of said at least one new sales order.

14. The method of claim 12, further comprising:
obtaining, at said computer processor, an input indicative of an operator override of said default rule for at least another one of said contracts; and
responsive to said input indicative of said operator override, refraining from updating, in said database on said persistent storage device, said at least one field comprising said corresponding contract end date for said at least at least another one of said contracts not within said subset of said portion of said contracts.

15. The method of claim 12, wherein said update data comprises data indicative of at least one replacement contract for at least one of said contracts, further comprising updating said at least one field comprising said corresponding contract end date for said at least one of said contracts by extending same to reflect an end date of said at least one replacement contract, with a contract engine software module embodied on a non-transitory storage medium and executing on said computer processor, said contract engine software module having encoded therein a default rule to extend said corresponding contract end date to reflect said end date of said replacement contract.

16. The method of claim 12, further comprising:
maintaining, on said persistent storage device, in said database of contracts, at least a second field for each of said contracts, said at least second field comprising review-based reliability status for a corresponding one of said contracts; and
responsive to said at least one user query, generating, with said computer processor, a signal to cause said display device to display said reliability status for a plurality of said contracts.

17. The method of claim 16, wherein said generating, with said computer processor, said signal to cause said display device to display said reliability status comprises:
generating, with said computer processor, a signal to cause said display device to display an indicator of a first color for those of said plurality of contracts for which said corresponding contract end date can be relied upon; and
generating, with said computer processor, a signal to cause said display device to display an indicator of a second color for at least a portion of those of said plurality of contracts for which said corresponding contract end date cannot be relied upon, based upon said update data.

18. The method of claim 16, wherein said generating, with said computer processor, said signal to cause said display device to display said reliability status comprises:
generating, with said computer processor, a signal to cause said display device to display the letters OK and a happy face emoticon for those of said plurality of contracts for which said corresponding contract end date can be relied upon; and
generating, with said computer processor, a signal to cause said display device to display an octagonal outline enclosing the word STOP for at least a portion of those of said plurality of contracts for which said corresponding contract end date cannot be relied upon, based upon said update data.

19. The method of claim 1, further comprising providing a system, wherein the system comprises distinct software modules, each of the distinct software modules being embodied on a non-transitory computer-readable storage medium, and wherein the distinct software modules comprise a database module and a user interface module;
wherein:
said maintaining of said database of contracts is carried out by said database module executing on said computer processor;
said obtaining of said at least one user query is carried out by said user interface module executing on said computer processor; and
said generating, with said computer processor, of said signal to cause said display device to display said histogram is carried out, at least in part, by said user interface module executing on said computer processor.

20. A method comprising the steps of:
maintaining, on a persistent storage device, a database of contracts, said database having at least one record for each of said contracts, said at least one record for each of said contracts including at least one field comprising a review-based reliability status;
obtaining, from an external application, at at least one computer processor in communication with said persistent storage device, updated data comprising at least one of a new contract and an exchange to an existing one of said contracts;
updating, in said database on said persistent storage device, said at least one field comprising said review-based reliability status for at least one of: at least one of said contracts and said new contract, based on said updated data; and
responsive to at least one user query, generating, with said computer processor, a signal to cause a display device to display said updated field comprising said review-based reliability status for said at least one of: said at least one of said contracts and said new contract.

21. The method of claim 20, wherein said generating, with said computer processor, said signal to cause said display device to display said updated field as a color-coded indicator of reliability.

22. The method of claim 20, further comprising providing a system, wherein the system comprises distinct software modules, each of the distinct software modules being embodied on a non-transitory computer-readable storage medium, and wherein the distinct software modules comprise a database module, a contract engine module, a user interface module, and an external program interface module;
wherein:
said maintaining of said database of contracts is carried out by said database module executing on said computer processor;
said obtaining of said updated data is carried out by said external program interface module executing on said computer processor;
said updating is carried out by said contract engine module executing on said computer processor; and
said generating, with said computer processor, of said signal to cause said display device to display said updated field is carried out, at least in part, by said user interface module executing on said computer processor.

23. A method comprising the steps of:
maintaining, on a persistent storage device, a database of contracts, said database having at least one record for each of said contracts, said at least one record for each of said contracts including at least one field comprising implementation date;
obtaining, at a computer processor in communication with said persistent storage device, at least one user query; and
responsive to said at least one user query, generating, with said computer processor, a signal to cause a display device to display a list comprising at least a portion of said contracts for which said implementation date field is blank.

24. The method of claim 23, further comprising:
determining that at least one of said contracts for which said implementation date field is blank has had a predetermined amount of monthly recurring revenue installed; and
responsive to said determining that said at least one of said contracts for which said implementation date field is blank has had said predetermined amount of monthly recurring revenue installed, automatically populating said implementation date field with a date on which said predetermined amount of monthly recurring revenue has been installed.

25. The method of claim 24, wherein said predetermined amount of monthly recurring revenue comprises ninety percent of total monthly recurring revenue.

26. The method of claim 23, further comprising providing a system, wherein the system comprises distinct software modules, each of the distinct software modules being embodied on a non-transitory computer-readable storage medium, and wherein the distinct software modules comprise a database module and a user interface module, further comprising querying said database based on said at least one user query;
wherein:
said maintaining of said database of contracts is carried out by said database module executing on said computer processor;
said obtaining of said at least one user query is carried out by said user interface module executing on said computer processor;
said querying of said database based on said at least one user query is carried out by said database module executing on said computer processor; and
said generating, with said computer processor, of said signal to cause said display device to display said list is carried out, at least in part, by said user interface module executing on said computer processor.

27. An apparatus comprising:
a memory;
at least one processor, coupled to said memory;
a display device in communication with said at least one processor; and
a persistent storage device in communication with said at least one processor;
wherein said persistent storage device stores instructions which, when loaded into said memory, configure said at least one processor to be operative to:
maintain, on said persistent storage device, a database of contracts, said database having at least one record for each of said contracts, said at least one record for each of said contracts including at least one field comprising a corresponding contract end date;
obtaining at least one user query; and
responsive to said at least one user query, generate a signal to cause said display device to display a histogram of said corresponding contract end date for at least one of said contracts.

28. An article of manufacture comprising a tangible non-transitory machine readable recordable storage medium with instructions recorded thereon which, when executed by a processor, cause said processor to be operative to:
maintain a database of contracts, said database having at least one record for each of said contracts, said at least one record for each of said contracts including at least one field comprising a corresponding contract end date;
obtain at least one user query; and
responsive to said at least one user query, generate a signal to cause a display device to display a histogram of said corresponding contract end date for at least one of said contracts.
